(19) United States
(12) Patent Application Publication
(10) Pub. No.: US 2026/0251195 A1
(43) Pub. Date: Aug. 27, 2026

(54) DEVICE COOLING SYSTEM AND METHOD

(71) Applicant: OGAB LTD, Bridgewater (GB)

(72) Inventors: Osama Elogab, Taunton (GB); Zachary Elogab, Taunton (GB)

(21) Appl. No.: 19/643,317

(22) Filed: Apr. 9, 2026

Related U.S. Application Data
(63) Continuation of application No. PCT/GB2023/052613, filed on Oct. 9, 2023.

(51) Int. Cl. F16D 65/78; B60T 5/00; B60T 17/22; F16D 66/00

(52) U.S. Cl. CPC F16D 65/78; B60T 5/00; B60T 17/22; F16D 66/00; F16D 2065/783; F16D 2066/001

(57) ABSTRACT

The action of braking generates massive amounts of heat, and brake components have a relatively narrow temperature window within which they can operate; their performance degrades drastically when they exceed their maximum temperature ratings. It is known to install brake ducts, which channel air from a high-pressure source (usually the front surface of the vehicle) to the brake rotor; however, the airflow is closer to laminar and tends to leave hot air in eddies and concave regions around the device. Many other devices are at risk of overheating too, including gearboxes and batteries, in all types of vehicles (e.g. cars, planes, lorries, trains, etc.). The present invention draws air from around the device, including from indentations and concave regions, rather than just blowing air past exposed regions.

### RELATED APPLICATIONS

This application claims the benefit under 35 U.S.C. § 120, and is a continuation, of co-pending International Application PCT/GB2023/052613, filed Oct. 9, 2023 and designating the US. This International application is incorporated by reference herein in its entirety.

### FIELD

The present invention relates generally to a device cooling system and a method of reducing the temperature of a device and finds particular, although not exclusive, utility in automotive and aeronautical braking systems.

### BACKGROUND

The action of braking generates massive amounts of heat, and brake components have a relatively narrow temperature window within which they can operate; their performance degrades drastically when they exceed their maximum temperature ratings.

Brake rotors (i.e. brake discs) are usually designed to dissipate heat. Aerodynamic cooling of brake discs through convection is the primary mechanism by which the brake discs are cooled; however, in vehicles having a wheel well (such as cars) and in vehicles where the brake rotors are disposed within the barrel of the wheel, air around the brake discs is turbulent and relatively slow-moving (for instance when compared to the speed of the vehicle). This causes a heat build-up around the brake components and diminishes their ability to shed that heat.

It is known to install brake ducts, which channel air from a high-pressure source (usually the front surface of the vehicle) to the brake rotor; however, the airflow is closer to laminar and tends to leave hot air in eddies and concave regions around the device.

Many other devices are at risk of overheating too, including gearboxes and batteries, in all types of vehicles (e.g. cars, planes, lorries, trains, etc.). For example, conventional approaches to cooling gearboxes involve the supply of a suitable amount of lubricant to act as a heat sink or coolant; if overheating is still a problem, using a greater quantity of lubricant and moving it toward and away from the device more quickly is often tried.

### SUMMARY

According to a first aspect of the present invention, there is provided a device cooling system, comprising: a device to be cooled; a first compressor configured to produce a first stream of gas; and a first air amplifier arranged to receive the first stream of gas and eject the first stream of gas over a Coandă surface, the first air amplifier configured to entrain ambient air from an inlet with the ejected first stream of gas to produce a second stream of gas, wherein the inlet of the first air amplifier is disposed adjacent to the device to be cooled and the first air amplifier is arranged to draw air into the inlet from around the device to be cooled.

In this way, air may be drawn from around the device, including from indentations and concave regions, rather than just being blown past exposed regions.

The first compressor may merely comprise an inlet arranged to collect air from the front of the vehicle so that ram pressure of a vehicle’s movement will provide high pressure air. Alternatively or additionally, the first compressor may comprise a pump (e.g. an air pump) to supply air. The pump may be electrically driven, or mechanically linked to the vehicle’s crank shaft and/or rotor blades. However, in preferred embodiments, the pump may be driven by a turbo. That is, exhaust gases may drive a turbo that in turn is used to drive the pump for providing high pressure air into the inlet.

The first compressor may comprise a pump, for instance an air pump. The first stream of gas may comprise a first stream of air. The first stream of gas may be above ambient, and may comprise a comprise a compressed air stream.

The first air amplifier (also known as a bladeless fan) may comprise a device which uses a first amount of compressed air to generate a second flow of air larger than the first amount. The first air amplifier may operate by taking advantage of an aerodynamic effect known as “the Coandă effect”. The Coandă surface may be a curved surface. The first air amplifier may increase airflow by up to 40 times, in particular a factor of between 5 and 18 times. For example, the air amplifier may be an air multiplier (RTM).

The first air amplifier may comprise a plurality of air amplifiers. For example, one air amplifier may be located at a first location adjacent to the device, and another air amplifier may be located at a second location adjacent to the device.

The first air amplifier may take the first stream of gas and eject it though an air outlet adjacent to a “Coandă” surface, thereby entraining surrounding air. In particular, the air outlet may be configured to eject the gas substantially over the Coandă surface.

The Coandă surface may be located around an internal perimeter of the passage. In particular, the Coandă surface may form a closed loop around the internal perimeter of the passage. Similarly, the air outlet may be located around an internal perimeter of a passage. In particular, the air outlet may form a closed loop around the internal perimeter of the passage. The air outlet may comprise a ring nozzle.

The first stream of gas may have a pressure of between 1bar and 4bar, in particular between 2bar and 3bar, more particularly approximately 2.5bar.

The first stream of gas may be conveyed to the first air amplifier via a feed line.

The first stream of gas may have a temperature below ambient. In this way, air being supplied to the first air amplifier may be more dense than ambient air. However, in alternative arrangements the compressed air stream may have a temperature above ambient, or a temperature that is substantially equal to ambient.

The second stream of gas may be a combination of the first stream of gas and the entrained ambient air.

The device cooling system may further comprise a screen for filtering the ambient air prior to its entrainment by the first air amplifier. In this way, damage to the first air amplifier from grit and/or particulates can be prevented. The screen may comprise a grille and/or mesh.

The device cooling system may further comprise a controller configured to control supply of the first stream of air.

The device cooling system may further comprise a temperature sensor configured to monitor a temperature of the device and the controller configured to control supply of the first stream of air in response thereto.

The device may form part of a vehicle, such as a car, van, lorry, motorcycle, aircraft, helicopter, or any other similar vehicle.

The device may comprise a brake, and the system may further comprise a braking sensor configured to monitor vehicle braking, and the controller may be configured to control supply of the first stream of air in response thereto. In this way, the braking sensor and controller may control the brake duct system to cool the brake system during braking.

The device cooling system may further comprise: a second compressor configured to produce a third stream of gas; and a second air amplifier arranged to receive the third stream of gas and eject the third stream of gas over a Coandă surface, the second air amplifier configured to entrain ambient air from an inlet with the ejected third stream of gas to produce a fourth stream of gas from an outlet, the outlet of the second air amplifier disposed adjacent to the device to be cooled.

The second air amplifier may be arranged to deliver air to a region around the device. In this way, indentations and concave regions may be further minimised and/or the rate of cooling the device may be increased.

The second compressor may comprise any or all of the same features as the first compressor. The first compressor may comprise the second compressor; that is, they may be the same unit, configured to deliver the first and third streams of gas to the first and second air amplifiers respectively.

The second air amplifier may comprise any or all of the same features as the first air amplifier.

The controller may be configured to control supply of the third stream of air.

The controller may be configured to control supply of the third stream of air in response to the temperature sensor.

The third stream of gas may have a pressure of between 1bar and 4bar, in particular between 2bar and 3bar, more particularly approximately 2.5bar.

The third stream of gas may be conveyed to the second air amplifier via a feed line.

The third stream of gas may have a temperature below ambient. In this way, air being supplied to the second air amplifier may be more dense than ambient air. However, in alternative arrangements the compressed air stream may have a temperature above ambient, or a temperature that is substantially equal to ambient.

The fourth stream of gas may be a combination of the third stream of gas and the entrained ambient air.

The device cooling system may form part of an exhaust manifold, the exhaust manifold configurable for use with all types of vehicles (e.g. cars, planes, lorries, trains, etc.).

According to a second aspect of the present invention, there is provided a method of reducing the temperature of a device, the method comprising: providing the device cooling system of the first aspect; and controlling supply of the first stream of air.

### BRIEF DESCRIPTION OF THE ACCOMPANYING DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a perspective view of an air amplifier.

FIG. 2 shows plan views of the air amplifier of FIG. 1.

FIG. 3 shows a cross-sectional view of the air amplifier of FIGS. 1 and 2, taken along the line A-A in FIG. 2.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances.

The principles of the invention will now be described by a detailed description of at least one drawing relating to exemplary features of the invention. It is clear that other arrangements can be configured according to the knowledge of persons skilled in the art without departing from the underlying concept or technical teaching of the invention, the invention being limited only by the terms of the appended claims.

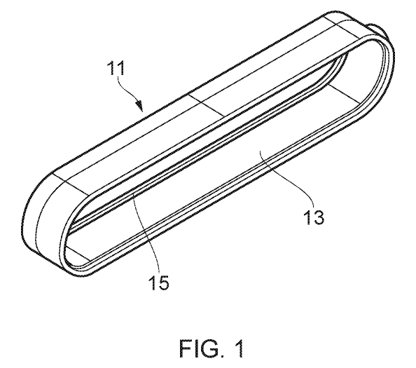

FIG. 1 is a perspective view of an air amplifier. The air amplifier comprises a closed loop 11. In particular the closed loop 11 is substantially prismatic in form, having an axial cross section that is substantially lozenge-shape; that is, having two opposing ends that are semi-circular connected by substantially flat and parallel upper and lower walls.

On an interior surface of the closed loop 11 is provided a Coandă surface 13 that extends around an entire internal periphery of the interior surface. At one axial end of the interior surface, adjacent to the Coandă surface 13 is a compressed air outlet 15. The compressed air outlet 15 is arranged in the form of a ring that extends around an entire internal periphery of the interior surface, and is configured to eject air over the Coandă surface 13.

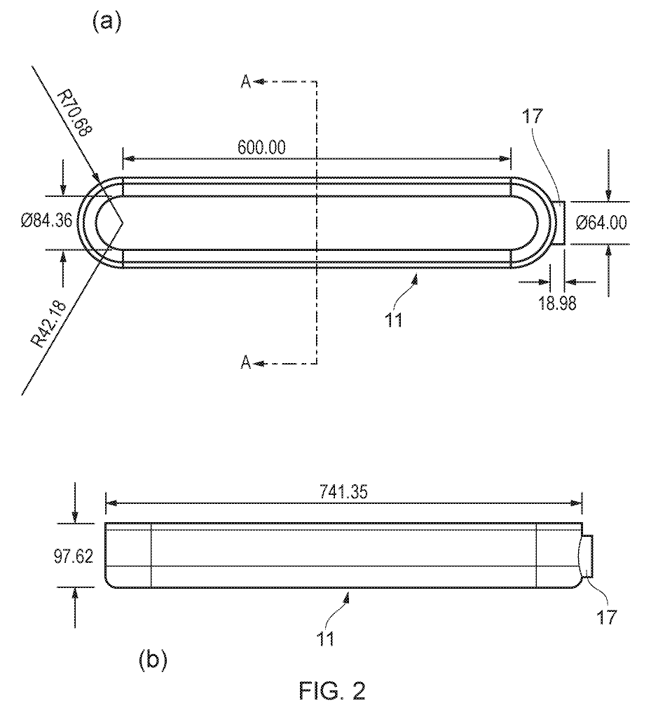

FIG. 2(a) shows a front axial plan view of the air amplifier of FIG. 1. FIG. 2(b) shows a bottom-up plan view of the air amplifier of FIG. 1. A compressed air inlet 17 is shown on the right-hand side thereof, for supplying a compressed air stream into an interior of the closed loop 11. Typical measurements are shown in millimetres, but any or all of these could vary by up to an order of magnitude from those shown and still be effective.

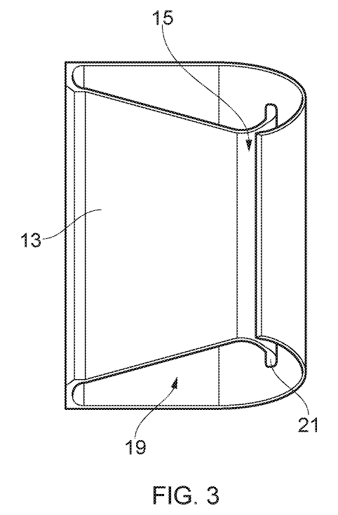

FIG. 3 shows a cross-sectional view of the air amplifier of FIGS. 1 and 2, taken along the line A-A in FIG. 2. The interior volume 19 is shown hollow, as this can be supplied by the compressed air inlet 17 with compressed air; however, other internal arrangements are also possible, in which compressed air is fed directly to the compressed air outlet 15.

Inside the compressed air outlet 15 is a guiding vane for ensuring directional flow of compressed air out of the compressed air outlet 15, such that it flows over the surface 13.

1. A device cooling system, comprising:
a device to be cooled;
a first compressor configured to produce a first stream of gas; and
a first air amplifier arranged to receive the first stream of gas and eject the first stream of gas over a Coandă surface, the first air amplifier configured to entrain ambient air from an inlet with the ejected first stream of gas to produce a second stream of gas,
wherein the inlet of the first air amplifier is disposed adjacent to the device to be cooled and the first air amplifier is arranged to draw air into the inlet from around the device to be cooled.

2. The device cooling system of claim 1, further comprising a controller configured to control supply of the first stream of air.

3. The device cooling system of claim 1, further comprising a temperature sensor configured to monitor a temperature of the device and a controller configured to control supply of the first stream of air in response thereto.

4. The device cooling system of claim 1, wherein the device comprises a brake, the system further comprises a braking sensor configured to monitor vehicle braking, and a controller is configured to control supply of the first stream of air in response thereto.

5. The device cooling system of claim 1, further comprising:
a second compressor configured to produce a third stream of gas; and
a second air amplifier arranged to receive the third stream of gas and eject the third stream of gas over a Coandă surface, the second air amplifier configured to entrain ambient air from an inlet with the ejected third stream of gas to produce a fourth stream of gas from an outlet, the outlet of the second air amplifier disposed adjacent to the device to be cooled.

6. A method of reducing the temperature of a device, the method comprising:
providing the device cooling system of claim 1; and
controlling supply of the first stream of air.
